(19) United States
(12) Patent Application Publication
(10) Pub. No.: US 2025/0010481 A1
(43) Pub. Date: Jan. 9, 2025

(54) ROBOTIC STACKING COLD START

(71) Applicant: Dexterity, Inc., Redwood City, CA (US)

(72) Inventors: Neeraja Abhyankar, Menlo Park, CA (US); Harry Zhe Su, Union City, CA (US); Joseph W. Weber, Kirkland, WA (US); Kevin Jose Chavez, Redwood City, CA (US); Neeraj Basu, San Francisco, CA (US); Cuthbert Sun, San Francisco, CA (US); Vikram Ramanathan, Menlo Park, CA (US); Arth Beladiya, Santa Clara, CA (US)

(21) Appl. No.: 18/750,263

(22) Filed: Jun. 21, 2024

Related U.S. Application Data
(60) Provisional application No. 63/523,339, filed on Jun. 26, 2023.

(51) Int. Cl. B25J 9/16

(52) U.S. Cl. CPC B25J 9/1697

(57) ABSTRACT

Performing a “cold start” of a robotic stacking operation is disclosed. In various embodiments, estimated state information representing an estimated state of one or both of a receptacle and one or more objects stacked on or in the receptacle is stored. An indication is received that the estimated state information is not suitable to make a next placement decision with respect to a next object to be stacked on or in the receptacle. Constructed estimated state information is generated at least in part by processing sensor information generated by one or more sensors positioned and configured to generate sensor information providing an at least partial view of one or both of the receptacle and the one or more objects stacked on or in the receptacle.

### CROSS REFERENCE TO OTHER APPLICATIONS

This application claims priority to U.S. Provisional Patent Application No. 63/523,339 entitled ROBOTIC PALLETIZATION COLD START filed Jun. 26, 2023, which is incorporated herein by reference for all purposes.

### BACKGROUND OF THE INVENTION

During robotic stacking (or other handling) of boxes or other stacked items/objects, e.g., on a pallet, in a truck, container, or other receptacle, etc., the situation may arise where a pallet/pile is partially built (by a human/an automated system), and the robot has no/incorrect knowledge of placed boxes.

Robotic palletization/stacking systems may maintain a representation of the pallet/stack state, to enable the robotic system to leverage an optimal and efficient bin-packing/pallet stacking/decision-making algorithm. This representation and understanding of pallet/stack state may be simplified and/or enhanced using sensor input, such as images generated by one or more cameras.

A robotic system's understanding of the current state of a pallet or other destination or receptacle may be based at least in part from prior knowledge of the system's decisions and actions, e.g., in stacking items on the pallet or stack. But in some situations, a robot may be tasked to begin/resume stacking items without such prior knowledge.

### BRIEF DESCRIPTION OF THE DRAWINGS

Various embodiments of the invention are disclosed in the following detailed description and the accompanying drawings.

FIG. 1 is a diagram illustrating an embodiment of a robotic system.

FIG. 2 is a block diagram illustrating an embodiment of elements of a robotic system configured to make placement decisions based on estimated state.

FIG. 3 is a flow diagram illustrating an embodiment of a process to make placement decisions based on estimated state.

FIG. 4 is a flow diagram illustrating an embodiment of a process to restore or establish estimated state.

FIG. 5A through 5D illustrate an example of using sensor data to reconstruct state in an embodiment of a robotic system configured to begin or resume a palletization or other stacking operation from a cold start.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques are disclosed to begin stacking, unstacking, or otherwise handling boxes or other items from a partial stack (e.g., on a pallet, or in a truck or other container) without prior knowledge reflecting how the stack was constructed.

In various embodiments, an initial estimate of the state of a stack (e.g., pallet) state is constructed by a robotic system using only sensor data, without prior knowledge reflecting how the stack was constructed. The estimated state may be used to start/resume palletization (or other item handling operations) from that point. Resuming/initiating robotic stacking (or other item handling operations) based on an estimate so constructed is sometimes referred to herein as a “cold start”.

Techniques are disclosed to determine when conditions are such that a “cold start” is or may be required, e.g., when no information is available about how the stack was constructed or, in some embodiments, in response to a determination that an estimated state of the stack cannot be reconciled with other information, such as image or other sensor data, observed stability or instability of the stack, failed attempts to place (or grasp) items, etc.

In various embodiments, a robotic system as disclosed herein may initiate a “cold start” based at least in part on a determination that the system has incorrect knowledge of the state. The following are examples of conditions that could result in the system having incorrect knowledge of state:
Placement errors (e.g., bad grip, imprecise motion, bumps, collisions) resulting in boxes not being where the system thinks they are or should be.
Stacks becoming unstable and potentially collapsing or partly collapsing; boxes becoming crushed or otherwise deformed.
A human or other robotic worker entering the work zone (due to an unrelated reason, e.g., resetting or fixing a component, re-stacking a fallen box) and thus changing the state in a way the system did not intend or know about.

In various embodiments, in response to detecting that the system has incorrect knowledge of the state, the system may initiate a cold start. In some embodiments, the system may initiate a cold start at least in part by using sensor data (or requesting help from a module or entity configured to use sensor data) to construct an estimate of pallet/stack/pile/other state.

In various embodiments, a robotic system as disclosed herein may initiate a “cold start” based at least in part on a determination that the system has no knowledge of the state and requires reconstruction from sensor data.

Raw sensor data may be too complex to serve as a direct input to an efficient packing algorithm, without knowledge/estimate of stack state. Sensor data may be too noisy for such an algorithm. Sensor data may be insufficient (work zone state only partially visible) and needed “filling-in”. Sensor data may not be guaranteed to satisfy certain assumptions made by packing algorithm (physical stability, feasibility).

As a result, in various embodiments, techniques disclosed herein are used to perform a “cold start” in which raw sensor data is processed to generate or reconstruct a representation of the pallet or stack state the form and content of which can be used by the decision engine (i.e., the module implementing and applying the packing algorithm) to make placement decisions.

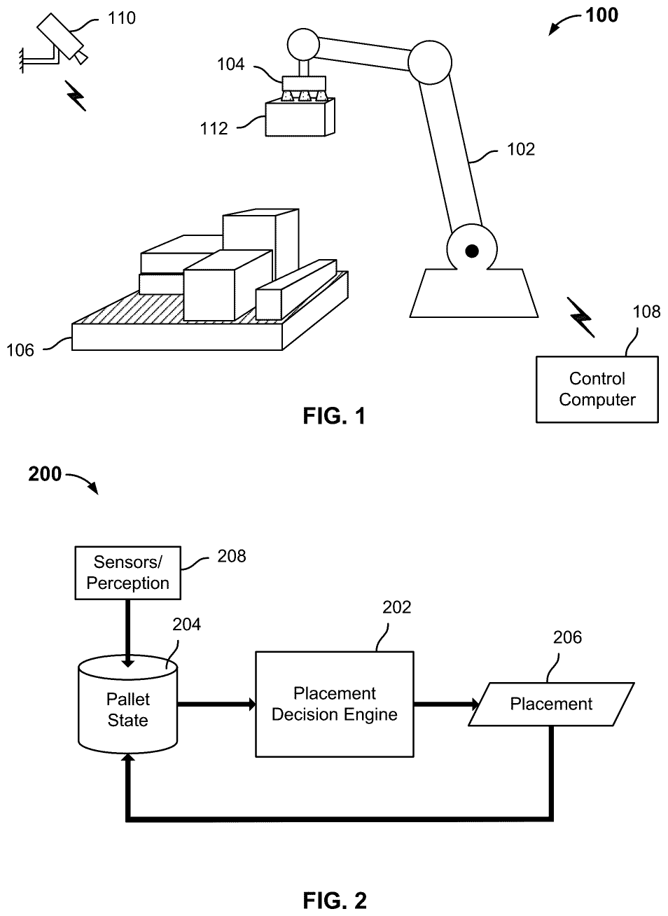

FIG. 1 is a diagram illustrating an embodiment of a robotic system. In the example shown, system 100 includes robotic arm 102 having suction type end effector 104. In the example shown, robotic arm 102 and end effector 106 are being used to stack boxes on pallet 106 under control of control computer 108. Control computer 108 uses image data from camera 110, which may be a 3D camera that provides both 2D (e.g., RGB) image data and depth information (e.g., point cloud or other depth pixels). In the state shown in FIG. 1, robotic arm 102 and end effector 104 are being used to add box 112 to the pallet.

In various embodiments, control computer 108 tracks an estimated state of the pallet 106 and boxes stacked thereon. For example, control computer 108 may updated an estimated state of the pallet each time robotic arm 102 and end effector 104 are used to successfully place an box on the pallet 106, either on an available location on the top surface of the pallet 106 or stacked on top of one or more boxes placed previously on pallet 106. The dimensions of the box, for example, may be used to update a geometric model of the pallet 106 and boxes stacked thereon. The geometric model and other information, such as image/depth information from camera 110, may be used to make placement decisions for subsequent boxes to be added to pallet 106. For example, a next box arriving via a conveyor or other source (not shown in FIG. 1) may be identified and/or one or more attributes of the box determined. The attributes (e.g., dimensions, weight, weight distribution, etc.) along with the geometric model and data from sensors such as camera 110 may be used to determine a placement for the box, e.g., to achieve objectives such as packing density, pallet/stack stability, etc.

In various embodiments, control computer 108 performs a check, prior to making a placement, to ensure the placement will be successful and will not result in instability or other problems. For example, the control computer 108 may simulate the placement and/or verify that the perceived state of the pallet 106 and/or boxes stacked thereon is (sufficiently) consistent with the estimated state, at least in relevant respects. If the placement passes the check, control computer 108 operates robotic arm 102 and end effector 104 to make the placement, e.g., by grasping the box, moving it through a planned trajectory, and placing the box at the location and in the orientation indicated by the placement.

If the placement fails the check, in various embodiments, a “cold start” or similar process is initiated to restore/repair/reconstruct the estimated state to a condition consistent with the perceived state and/or otherwise to a condition such that a placement determination can be made and implemented for the box. In various embodiments, image/depth data from camera 110 may be used to reconstruct the state. Since the raw image/depth data may not be usable to make, evaluate, and implement placement decisions, in various embodiments, the image/depth information is processed, as described herein, to generate (or regenerate) the estimated state.

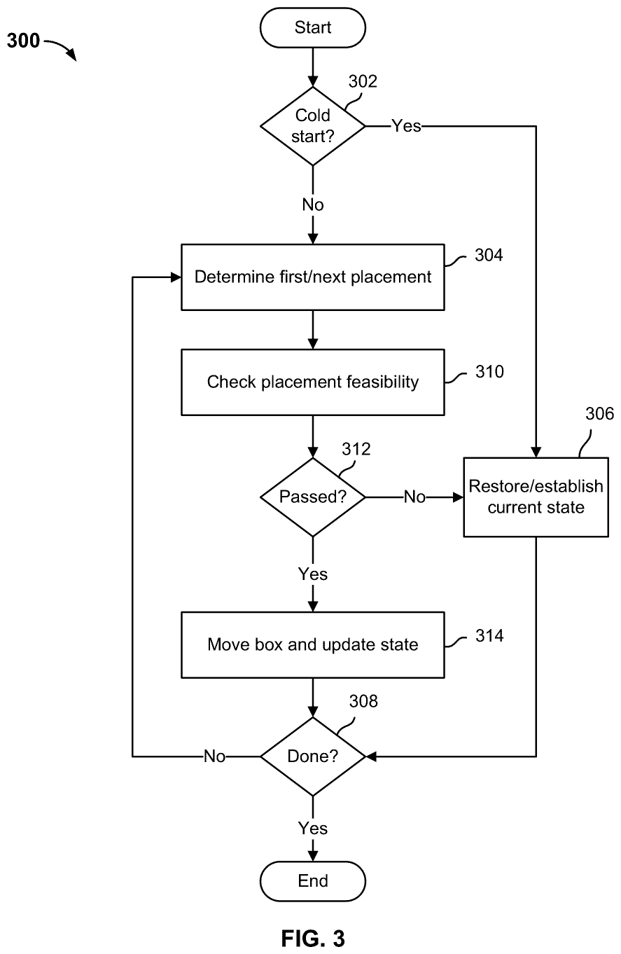

FIG. 2 is a block diagram illustrating an embodiment of elements of a robotic system configured to make placement decisions based on estimated state. In various embodiments, the functional blocks 200 of in FIG. 2 may be implemented (e.g., as software modules and/or processes) on a control computer, such as control computer 108 of FIG. 1. In the functional blocks 200 include a placement decision engine 202 configured to make placement decisions based on estimated and perceived pallet state 204. For example, each placement 206 may be determined by applying a placement (e.g., stacking) algorithm to data associated with the next box (or n boxes) to be placed, the attributes of boxes placed previously, imperatives such as stack stability and packing density, and estimated and perceived state information, e.g., estimated state based on previous placements and/or perceived state based on sensors/perception subsystem 208 (e.g., based on data from sensors such as camera 110).

In various embodiments, prior to making a placement 206, a system as disclosed herein performs a check, e.g., as described above, to verify that a contemplated placement will result in successful completion. If not, the system performs a “cold start” as disclosed herein, to restore the estimated state to a condition such that successful placement decisions can be made and implemented.

If checking the feasibility of a placement and/or in reconstructing pallet or other stack estimated state based on sensor data, the decision-making engine may enforce certain constraints on its input. For example, one or more of: the input is a list of cuboids; all cuboids are axis-aligned; no two boxes intersect; and each cuboid is supported by the floor/other cuboids (to not be deemed “unstable” according to some heuristic) and/or the set of cuboids, when input into a physics simulation engine, do not move/fall.

Noisy data or boxes broken down into too many components may result in increased processing time, as opposed to a compact representation that still satisfies the fidelity requirements. In some embodiments, the system may induce preferences on the complexity of the input state. For example, a representation (based on sensor data) that includes a multitude of small voxels may be simplified by merging many voxels into larger cuboids, leading to faster downstream processing. RGB or other image segmentation, knowledge of typical and/or specific box sizes, identifying voxels with a same or nearly same height (e.g., z-axis location of top of voxel), drawing bounding boxes/cuboids, etc. may be used to simplify a representation comprising a multitude of voxels into a simpler representation comprising a manageable number of stacked cuboids.

In some cases, sensor data being used to reconstruct estimated state (i.e., “cold start”) my include insufficient information. For example, the camera(s) may have captured in incomplete view, due to their positions relative to the pallet or other stack, obstructions partially blocking the view, sensor properties, environmental conditions, etc. Sensor data may be sparse, noisy, or both. For example, a sensor positioned above and to the right of a box or stack of boxes may not have a clear view of the left face(s) of the box(es). The sensor and/or a downstream component in a perception subsystem may imperfectly attempt to fill gaps, such as by interpolating from the information the sensor was able to perceive. In some cases, the interpolated representation of the obscured or poorly perceived face of the box may deviate from the actual real world state, e.g., representing as a sloped, convex, or concave surface a face that in fact is flat and vertical.

In another example, sensors may generate data that omits parts of boxes. For example, a segmented image may result in a state that violates one or more real world constraints, such as that the bottom of a box must rest on the top surface of the pallet or a box below it.

In various embodiments, a system as disclosed herein may perform one or more of the following to reconstruct estimate state based on incomplete or otherwise imperfect sensor/perception data:

Sensor data complexity: Target simplified data representation defined. Fidelity requirements defined. Transformations to the space of defined allowable representations.

Sensor data noise: Denoising stage incorporated. Simplification of data representation used to eliminate noise.

Sensor data was insufficient (work zone state only partially visible) and needed “filling-in”: Sensor data confidence inferred. Data artificially augmented to “fill out” missing/underconfident areas.

Physical Feasibility Assumptions: Sensor data representation augmentation undergone further (iterative) transformations to satisfy bin-packing algorithm assumptions, such as stability, box must be supported from below, etc.

Closed-loop feedback: Solution incorporated into robotic system with a criteria-based process (i.e., when and how much to rely on sensor data).

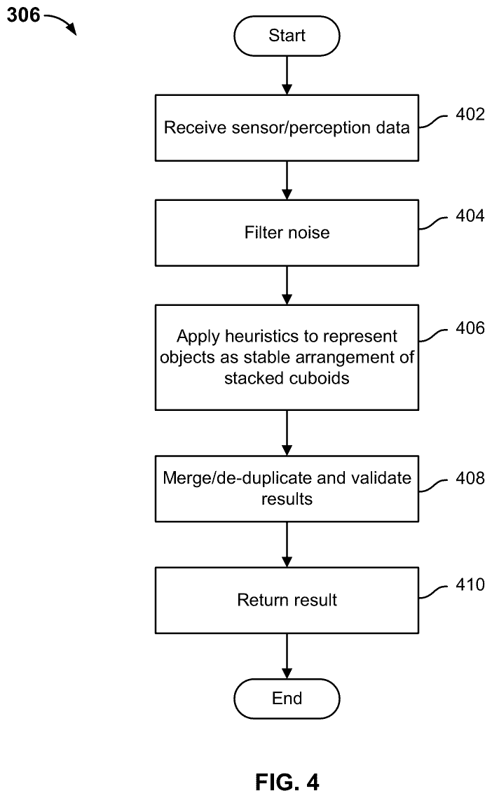

FIG. 3 is a flow diagram illustrating an embodiment of a process to make placement decisions based on estimated state. In various embodiments, process 300 of FIG. 3 may be implemented by a control computer, such as control computer 108 of FIG. 1. In the example shown, at 302 a determination is made as to whether a need to perform a “cold start” (i.e., construct or reconstruct estimated state). For example, the system may be restarted or may be deployed to continue or complete building a partly completed pallet or other stack.

If at 302 it is determined that a cold start is not needed, then at 304 the first (or next) placement decision is made. If a cold start is required (302), then at 306 a cold start process is performed to restore/establish estimated current state. For example, sensor data may be processed, as disclosed herein, to generate a representation of estimated state that is sufficient complete, accurate, and simple to be used to make and implement placement decisions. Once estimated state has been restored/established, at 306, processing return (via 308) to making the first/next placement decision, at 304.

Once the first/next placement decision has been made, at 304, the feasibility/suitability of the placement is checked, at 310. For example, the system implementing the process 300 may evaluate sensor data, perform simulated placement, and/or assess the stability of the stack after the prospective placement. If the placement passes the check (312), the box (or other item) is grasped, moved, and placed according to the placement decision (314).

If the placement indicated by the placement decision does not pass the check (310, 312), the process 300 advances to step 306, in which the estimated state is restored, e.g., based on sensor data, as disclosed herein.

Processing continues until done (308), e.g., all boxes have been placed or the system is turned off or redirected to other work.

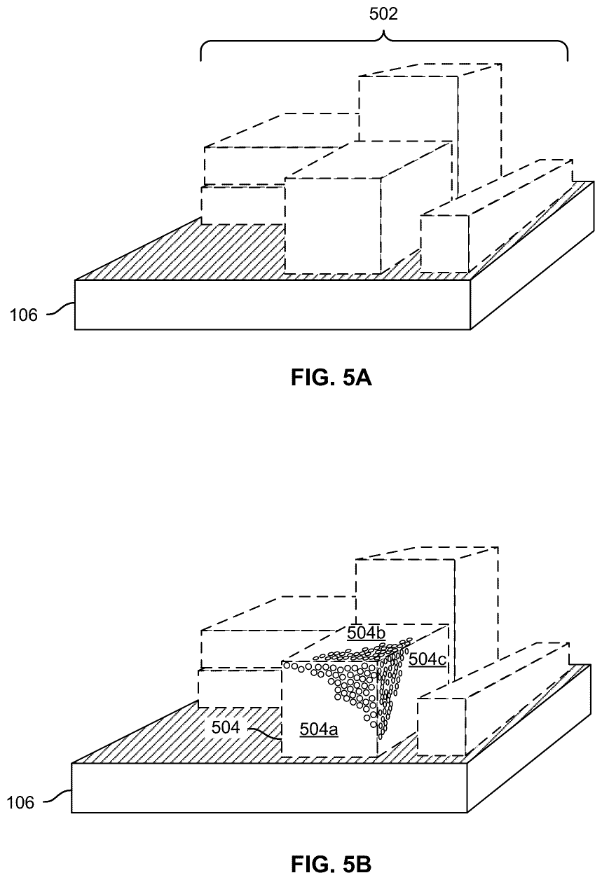

FIG. 4 is a flow diagram illustrating an embodiment of a process to restore or establish estimated state. In some embodiments, the process of FIG. 4 is used to perform step 306 of FIG. 3. In the example shown, at 402, sensor or other perception data is received. At 404, the sensor data is filtered to remove or reduce noise. For example, image/depth data associated with parts of a scene not comprising the pallet or other stack may be removed and/or signal processing or other processing may be performed to remove or reduce noise. At 406, one or more heuristics may be applied to transform the sensor data into a representation of estimated state that satisfies one or more constraints and/or operational requirements, e.g., by representing the state as a stable arrangement of a computationally manageable number of stacked cuboids. Processing performed at 406 may include merging a multitude of adjacent voxels into a single cuboid, filling in gaps in perception to form cuboids from partial views of boxes, ensuring each cuboid rests on a box (i.e., cuboid) or pallet below it, etc.

In some embodiments, processing at 406 may include performing physics-based simulation and/or estimation of stability. An estimated state that is determined not to be stable may be modified, e.g., incrementally, until an estimated state that is both consistent with perceived state and stable is determined. In some embodiments, stability may be assessed via simulation, e.g., using a physics engine or other simulator. The simulation may produced first order derivatives, gradients, and/or other information indicating a direction, nature, and/or extent of modification needed to be made to the estimated state to determine a state that meets the stability expectation and/or criteria.

At 408, data from various sensors and/or resulting from the heuristics applied at 406 are merged and de-duplicated and the results are validated, e.g., by using a physics engine to verify the resulting representation is stable and/or checking against sensor data to detect inconsistencies, etc.

At 410, the resulting representation is returned for use as the generated/restored estimated state.

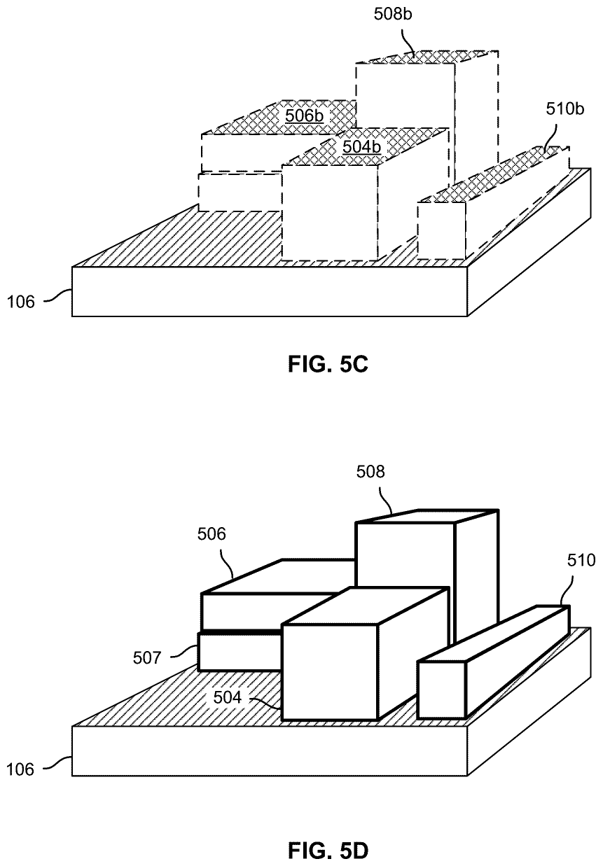

FIG. 5A through 5D illustrate an example of using sensor data to reconstruct state in an embodiment of a robotic system configured to begin or resume a palletization or other stacking operation from a cold start.

FIG. 5A shows in outline a set of boxes 502 stacked on pallet 106. For example, the arrangement shown in FIG. 5A may reflect the real world result of a robotic system as disclosed herein having been used to stack the boxes 502 on pallet. The boxes are shown in outline to indicate that the system has determined the need to reconstruct its estimated state, i.e., the internal representation of state it uses, along with perception information generated based on cameras and/or other sensors, to make, evaluate, and perform placements.

FIG. 5B illustrates an example of 3D camera data being used to reconstruct estimated state. As shown in FIG. 5B with respect to box 504 on pallet 106, having a front face 504a, top surface 504b, and right side face 504c, raw 3D camera (or other depth) data alone, represented in FIG. 5B by the clusters of small circles in the upper right corner of front face 504a, near right corner of top surface 504b, and upper left corner of right side face 504c, may not be sufficient to reconstruct the estimated state of the pallet 106. Such a pattern of depth pixels may be received, e.g., from a camera positioned above and to the right of the pallet 106, as shown. In various embodiments, image data as shown in FIG. 5B may be filtered, to remove noise, and augmented, e.g., to determine a cuboid representative of box 504 that more closely approximates the actual location, orientation, and shape of box 504. For example, the bottom of the box may be inferred as resting on the pallet, since no other depth pixels appear below those shown, and other extents of the box 504 may be inferred based on the assumption that the box 504 would have been placed reasonably close to adjacent boxes, etc.

In some embodiments, noise removal and/or voxel merging may be based at least in part on expectations derived from prior knowledge of the items to be handled. For example, if boxes are handled they may be expected to comprise cuboids having flat faces. If the sizes or range of sizes are known, the faces may be expected to have at least certain minimum dimensions, for example.

FIG. 5C illustrates an example of processing raw image/depth data to filter out less reliable portions of the data. In this case, a camera may be positioned above the pallet 106 and looking down. The camera may have produced a reliable view of the top surfaces of the boxes (504b, 506b, 508b, and 510b), but may have produced noisy, incomplete, inaccurately interpolated, or otherwise unreliable data for the other parts of the boxes. As a result, in the example shown, data other than the top surfaces has been removed.

In various embodiments, the information as shown in FIG. 5C may be combined with data form other sources (e.g., cameras with views from other angles) and/or processed using one or more heuristics (e.g., boxes rest on a surface below, boxes stacks are assumed to be stable, etc.) to infer a complete reconstructed estimated state of the pallet 106 and boxes stacked thereon.

In various embodiments, depth pixel data such as that shown in FIG. 5C may be augmented or otherwise transformed based on information such as known properties of the object (here, a box with flat faces); camera viewpoint for confidence in data; local smoothness of the point cloud segment, etc., to fill out and completely infer cuboids to represent the boxes.

FIG. 5D shows a final result of estimated state as reconstructed via techniques disclosed herein. The estimated state represents the pallet 106 and boxes 504, 506, 507, 508, and 510 stacked thereon as a computationally manageable number of regularly placed cuboids, providing a tool that would be usable to quickly make accurate placement decisions with respect to boxes to be added to the pallet 106.

While in various embodiments described above a robotic system as disclosed herein is shown as being used to stack boxes on a pallet, techniques disclosed herein may be used in other contexts and embodiments, such as to stack items in a truck or other container, place items in a large box or other receptacle, building a stack on the floor, etc. In addition, while techniques disclosed herein are described with reference to stacking boxes, in other contexts and embodiments stackable items other than boxes may be stacked, such as trays, bins, regularly shaped items that are not boxes, and irregularly shaped items.

In various embodiments, the constraints imposed on or by the system, including those used to detect the need to perform a “cold start” as disclosed herein and/or to process sensor information to construct or reconstruct estimated state information as disclosed herein may vary, depending on the context, the items being handled, the requirements of a customer or other user, etc.

In various embodiments, techniques disclosed herein enable a robotic system to start or resume palletization and other stacking operations, including with respect to a partially loaded pallet or other partly formed stack, even if initially the system has no state information or determines it has incorrect state information.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A robotic system, comprising:
a memory configured to store estimated state information representing an estimated state of one or both of a receptacle and one or more objects stacked on or in the receptacle; and
a processor coupled to the memory and configured to:
receive an indication that the estimated state information is not suitable to make a next placement decision with respect to a next object to be stacked on or in the receptacle; and
store in the memory a constructed estimated state information generated at least in part by processing sensor information generated by one or more sensors positioned and configured to generate sensor information providing an at least partial view of one or both of the receptacle and the one or more objects stacked on or in the receptacle.

2. The system of claim 1, wherein the processor is further configured to generate said indication that the estimated state information is not suitable to make a next placement decision with respect to a next object to be stacked on or in the receptacle.

3. The system of claim 2, wherein the processor is configured to generate said indication at least in part by processing sensor information from said one or more sensors.

4. The system of claim 3, wherein the sensor information comprises one or both of image data and depth information.

5. The system of claim 3, wherein the sensor information indicates a perceived real-world state that is inconsistent with the stored estimated state information.

6. The system of claim 2, wherein the processor is configured to generate said indication at least in part by simulating performance of a propose placement of next object to be stacked on or in the receptacle.

7. The system of claim 1, wherein said indication that the estimated state information is not suitable to make a next placement decision comprises an indication that a proposed next placement would result in instability.

8. The system of claim 1, wherein said indication that the estimated state information is not suitable to make a next placement decision comprises an indication that a proposed next placement would result in damage to one or both of the next object to be placed and one or more objects in the stack.

9. The system of claim 1, wherein the processor is configured to process the sensor information at least in part by filtering the sensor information to remove noise.

10. The system of claim 1, wherein the processor is configured to process the sensor information at least in part by augmenting the sensor information to fill one or more gaps in the view of sensor information of one or both of a receptacle and one or more objects stacked on or in the receptacle.

11. The system of claim 1, wherein the receptacle comprises a pallet.

12. The system of claim 1, wherein the processor is further configured to determine and implement the next placement decision.

13. The system of claim 12, wherein the processor is further configured to update the estimated state information based at least in part on a result of implementing said next placement decision.

14. The system of claim 1, wherein the sensor information comprises a point cloud defining a partial image of an object stacked on or in the receptacle and the processor is configured to process the sensor information at least in part by determining one or more dimensions of the object and including in the constructed estimated state information data representing the object as a cuboid.

15. The system of claim 1, wherein the processor is configured to process the sensor information based at least in part on one or more of a position of the sensor, a feature of the sensor, and a configuration of the sensor.

16. The system of claim 1, further comprising a communication interface couple to the processor and configured to receive the sensor information.

17. The system of claim 1, wherein the processor is configured to generate the constructed estimated state at least in part by determining based on a simulation whether a candidate estimated state satisfies a stability criterion.

18. A method, comprising:
storing estimated state information representing an estimated state of one or both of a receptacle and one or more objects stacked on or in the receptacle;
receive an indication that the estimated state information is not suitable to make a next placement decision with respect to a next object to be stacked on or in the receptacle;
storing in the memory a constructed estimated state information generated at least in part by processing sensor information generated by one or more sensors positioned and configured to generate sensor information providing an at least partial view of one or both of the receptacle and the one or more objects stacked on or in the receptacle.

19. The method of claim 18, wherein said indication is generated based on sensor information from said one or more sensors and comprises an indication that a perceived real-world state is inconsistent with the stored estimated state information.

20. A computer program product embodied in a non-transitory computer readable medium and comprising computer instructions for:
storing estimated state information representing an estimated state of one or both of a receptacle and one or more objects stacked on or in the receptacle;
receive an indication that the estimated state information is not suitable to make a next placement decision with respect to a next object to be stacked on or in the receptacle;
storing in the memory a constructed estimated state information generated at least in part by processing sensor information generated by one or more sensors positioned and configured to generate sensor information providing an at least partial view of one or both of the receptacle and the one or more objects stacked on or in the receptacle.
